(19) United States
(12) Patent Application Publication
(10) Pub. No.: US 2025/0027273 A1
(43) Pub. Date: Jan. 23, 2025

(54) Coating Agent for Paper Base Material

(71) Applicant: Henkel AG & Co. KGaA, Dusseldorf (DE)

(72) Inventors: Chiho Sakoda, Osaka (JP); Yoshio Yoshida, Kyoto (JP)

(21) Appl. No.: 18/739,523

(22) Filed: Jun. 11, 2024

Related U.S. Application Data
(63) Continuation of application No. PCT/JP2022/045830, filed on Dec. 13, 2022.

(30) Foreign Application Priority Data
Dec. 14, 2021 (JP) 2021-202680

(51) Int. Cl. D21H 19/34; D21H 19/72; D21H 25/04

(52) U.S. Cl. CPC D21H 19/34; D21H 19/72; D21H 25/04

(57) ABSTRACT

A coating agent for paper base material is disclosed. The coating agent comprises: (A) cellulose with an average particle size of 1 μm to 40 μm; and (B) an aqueous resin emulsion, wherein the amount of component (A) per 100 parts by mass of the total amount of component (A) and component (B) in terms of solid content is more than 20 parts by mass and less than 50 parts by mass. The coating agent has excellent water resistance, oil resistance, blocking resistance, and surface coatability.

### TECHNICAL FIELD

The present invention relates to a coating agent for a paper base material and to a paper base material coated with the same.

### BACKGROUND ART

Due to concern over environmental issues, reduction in the use of plastic products is being encouraged worldwide. Plastic products do not decompose naturally and are difficult to dispose of. Incinerating plastics to dispose of them creates dioxins, which can cause air pollution. In recent years, plastic waste has been disposed of in the ocean, where it decomposes into debris on a microscopic level. The possibility of this debris being consumed by fish in the ocean, which are in turn consumed by humans, has raised concerns. Given these concerns, the replacement of plastics with paper base materials has been studied, and methods of processing paper base materials into packaging materials have been used for a long time, especially in the field of food packaging.

Processed paper such as laminated paper and greaseproof paper has been used as material for food packaging. Laminated paper and greaseproof paper are treated so that food-derived oils do not penetrate and reduce the strength of the paper and so that these oils do not get on the hands.

Laminated paper usually consists of a paper base material laminated with a polyethylene film. Due to heightened environmental awareness, there is growing demand to recycle laminated paper. However, the film portion remains an obstacle, and special equipment is needed to efficiently recycle laminated paper.

Fluorine-based resins are often used as an oil-resistant agent in oil-resistant paper. However, it has been difficult to use fluorine-based resins effectively because they generate inert gas when heated and some components in fluorine-based resins have a tendency to build up in the human body. However, fluororesins exhibit oil resistance even when a small amount is applied to a paper base material. Not using fluororesins is disadvantageous in terms of price because when a substitute resin product for a fluororesin is applied to a paper base material, the amount applied has to be increased. Also, blocking may occur when greaseproof paper coated with one of these substitutes is wound up. However, greaseproof paper coated with a synthetic resin emulsion is known to achieve both oil resistance and recyclability.

Patent Documents 1 and 2 disclose coating agents that address environmental concerns by using naturally derived cellulose instead of petroleum resins.

Patent Document 1 discloses a coating agent that is an aqueous dispersion containing cellulose nanofibers and a polyvinyl alcohol-based resin ([Claim 1], to [0033]). Patent document 1 mentions a paper barrier material in which this aqueous dispersion is applied to a paper base material ([0008]).

Patent Document 2 discloses a coating agent that is a dispersion of fine cellulose obtained by introducing carboxyl groups into fine cellulose derived from natural sources ([Claim 1], [0054], to [0043]). This patent document mentions that the base material on which this dispersion is applied is preferably paper or biodegradable plastic in order to address environmental concerns ([0069]).

### CITATION LIST

### Patent Literature

Patent Document 1: WO 2011/040547 A1
Patent Document 2: WO 2011/111612 A1

### SUMMARY OF INVENTION

### Technical Problem

The aqueous dispersion-type compositions described in Patent Documents 1 and 2 have excellent gas barrier properties, but cannot be said to completely satisfy high standards in terms of oil resistance and blocking resistance.

Also, paper base materials for packaging foods increasingly need to meet various performance requirements. For example, because the surface of paper base materials is uneven, when an aqueous dispersion-type composition is applied directly to the surface of the paper base material as a coating agent, the coating agent must have excellent coating properties on the uneven surface of the paper base material. Also, when a paper base material is used in a paper cup, the paper cup must remain water resistant and oil resistant when folded. When an aqueous dispersion-type composition is used as a primer, the primer must have the same performance as that of a paper cup.

It is an object of the present invention to solve this problem by providing a coating agent having water resistance, oil resistance, and blocking resistance that satisfies the levels required in the food industry while also having excellent paper base material surface coatability. Another object of the present invention is to provide a paper base material coated with this coating agent and a paper product containing this paper base material that have excellent oil resistance when folded.

### Solution to Problem

As a result of extensive research, the present inventor discovered that a coating agent for a paper base material with excellent water resistance, oil resistance, blocking resistance, and surface coatability could be obtained when an aqueous resin emulsion and a cellulose with an average particle size in a specific range are mixed together at a certain ratio. The present invention is a product of this discovery.

The following is the present invention and preferred aspects of the present invention.
1. A coating agent for a paper base material comprising: (A) cellulose with an average particle size of 1 μm to 40 μm; and (B) an aqueous resin emulsion, wherein the amount of component (A) per 100 parts by mass of the total amount of component (A) and component (B) in terms of solid content is more than 20 parts by mass and less than 50 parts by mass.
2. The coating agent for a paper base material according to 1 above, wherein the aqueous resin emulsion (B) contains an aqueous resin having a chemical structure derived from a carboxylic acid ester polymer.
3. The coating agent for a paper base material according to 1 or 2 above, wherein the aqueous resin emulsion (B) contains a carboxylic acid ester copolymer emulsion having an ethylene/ethylenic double bond.
4. The coating agent for a paper base material according to any of 1 to 3 above, wherein the aqueous resin emulsion (B) contains an ethylene/vinyl acetate copolymer emulsion.
5. The coating agent for a paper base material according to any of 1 to 4 above, further comprising starch (C).
6. The coating agent for a paper base material according to any of 1 to 5 above, wherein the coating agent is used as an undercoating applied to the paper base material surface.
7. A paper base material having a surface on which the coating agent for a paper base material according to any of 1 to 6 above has been applied.
8. A paper product having a paper base material according to 7 above.
9. A coating agent for a paper base material comprising: (A) cellulose with an average fiber length of 15 μm to 40 μm; and (B) an aqueous resin emulsion, wherein the amount of component (A) per 100 parts by mass of the total amount of component (A) and component (B) in terms of solid content is more than 20 parts by mass and less than 50 parts by mass.
10. A coating agent for a paper base material comprising: (A) cellulose with an average fiber diameter of 10 μm to 30 μm; and (B) an aqueous resin emulsion, wherein the amount of component (A) per 100 parts by mass of the total amount of component (A) and component (B) in terms of solid content is more than 20 parts by mass and less than 50 parts by mass.

### Effect of the Invention

An aspect of the present invention is able to provide a coating agent having excellent water resistance, oil resistance, blocking resistance, and surface coatability (paper base material surface coatability).

### MODE FOR EMBODYING THE INVENTION

One aspect of the present invention is a coating agent for a paper base material comprising: (A) cellulose with an average particle size of 1 μm to 40 μm (also referred to below as “component (A)” or “cellulose (A)”); and (B) an aqueous resin emulsion (also referred to below as “component (B)”), wherein the amount of component (A) per 100 parts by mass of the total amount of component (A) and component (B) in terms of solid content is more than 20 parts by mass and less than 50 parts by mass. The paper base coating agent in this aspect of the present invention has excellent oil resistance, blocking resistance, surface coatability, and water resistance. The various components will now be described.

< (A) Cellulose with Average Particle Size of 1 μm to 40 μm>

In the present specification, cellulose refers to a type of natural macromolecular compound in which a large number of β-glucose molecules are polymerized linearly with glycosidic bonds. Cellulose is the main component of plant cell walls and fibers and is the most abundant carbohydrate (polysaccharide) on earth.

The coating agent of the present invention contains (A) cellulose having an average particle size of 1 μm to 40 μm. The cellulose (A) is in the form of fine particles. There are no particular restrictions on the shape of the particles, which may be spherical particles (with a preferred aspect ratio (major axis/minor axis) of 1 to 1.1) or fibrous particles (with a preferred aspect ratio (fiber length/fiber diameter) that is greater than 1.1). The spherical particles may be spherical or substantially spherical. In one aspect of the present invention, the average particle size of the cellulose (A) is preferably from 5 μm to 35 μm, more preferably from 6 μm to 35 μm, and even more preferably from 6 μm to 12 μm. In the present embodiment, the cellulose (A) is known as microcellulose because it has a size mentioned above, which is different from that of cellulose nanofibers (CNF). When the average particle size of the cellulose (A) is within this range, a coating agent for a paper base material of the present invention has significantly better water resistance and surface coatability, and has a better balance between oil resistance and blocking resistance.

In the present embodiment, the particle size of cellulose refers to the maximum value of the distance between any two points on the surface of the cellulose. When the cellulose is spherical particles, the average particle diameter refers to a value based on the diameter, and when the cellulose is fibrous particles, the average particle diameter refers to a value based on the average fiber length. The fiber length of the cellulose (A) is the dimension in the longitudinal direction of the fiber, and the fiber diameter is the dimension in the direction orthogonal to the longitudinal direction.

When the cellulose particles are spherical, the average particle size can be measured using a scanning electron microscope (SEM), an atomic force microscope (AFM), or a laser diffraction particle size distribution analyzer. However, use of a particle size distribution analyzer is preferred in this aspect of the present invention. When the cellulose particles are fibrous, they are preferably measured using a scanning electron microscope (SEM) or an atomic force microscope (AFM). They may be difficult to measure using a laser diffraction particle size distribution analyzer. When measured using an SEM or AFM, the maximum length (fiber length and fiber diameter if necessary) of at least 100 cellulose particles is measured, and the average value is calculated.

Commercial products of cellulose (A) include Arbocel UFC 100 (standard value of average particle size: 6 to 12 μm), Arbocel BE 600-10 (average fiber length: 18 μm, average fiber diameter: 15 μm), and Arbocel BE 600-30 (average fiber length: 30 μm, average fiber diameter: 18 μm), all from Rettenmaier Japan Co., Ltd.).

Because Arbocel UFC 100 has a very spherical shape, the average particle size can be easily measured with a laser diffraction particle size analyzer. Because Arbocel BE 600-10 and Arbocel BE 600-30 fibers differ greatly in terms of dimensional size, the average fiber length refers to the average particle size in the present specification. Specifically, the average particle size of Arbocel BE 600-10 is 18 μm and the average particle size of Arbocel BE 600-30 is 30 μm.

In one aspect of the present invention, when (A) the cellulose is fibrous, the average fiber length is preferably from 15 to 40 μm and/or the fiber diameter is preferably from 10 to 30 μm. When the average fiber length and average fiber diameter of the cellulose (A) are within these ranges, a coating agent for a paper base material in the present invention has significantly better water resistance and surface coating, and an excellent balance between oil resistance and blocking resistance.

In the coating agent of the present invention, cellulose (A) is dispersed in an aqueous medium, which is used as a cellulose fiber dispersion. By using cellulose (A) as a dispersion, the coating agent has a better balance between water resistance and oil resistance.

### <(B) Aqueous Resin Emulsion>

In the embodiment of the present invention, “aqueous resin emulsion (B)” refers to an aqueous dispersion in which an aqueous resin is dispersed in an aqueous medium, and includes an aqueous resin and an aqueous medium. Here, “aqueous resin emulsion” is distinguished from an “aqueous resin.”

In the present specification, an aqueous resin refers to a polymer that is dispersible in an aqueous medium. “Aqueous medium” refers to water such as tap water, distilled water, or ion-exchanged water, but may include an organic solvent that is water-soluble or dispersible in water and that has poor reactivity with the raw materials (monomers, etc.) of the resin in the present invention, such as acetone or ethyl acetate. The aqueous resin emulsion (B) may also contain a water-soluble or water-dispersible monomer, oligomer, prepolymer and/or water-soluble resin, as well as additives that are commonly used to prepare an aqueous resin emulsion, such as emulsifiers, polymerizable emulsifiers, polymerization initiators, and/or chain extenders.

A coating agent for a paper base material in the present invention containing a water-based resin emulsion (B) has excellent water resistance, oil resistance, and oil resistance when folded.

The aqueous resin is obtained by polymerizing a polymerizable unsaturated monomer (b). In the present embodiment, “polymerizable unsaturated monomer” refers to a radically polymerizable monomer having an ethylenic double bond. The expression “ethylenic double bond” refers to a double bond between carbon atoms that can undergo a polymerization reaction (radical polymerization). Examples of functional groups having an ethylenic double bond include vinyl groups (CH₂═CH—), (meth) allyl groups (CH₂═CH—CH₂— and CH₂═C(CH₃)—CH₂—), (meth) acryloyloxy groups (CH₂═CH—COO— and CH₂═C(CH₃)—COO—), (meth) acryloyloxyalkyl groups (CH₂═CH—COO—R— and CH₂═C(CH₃)—COO—R—), and —COO—CH═CH—COO—. The polymerizable unsaturated monomer (b) may be one type of monomer or a combination of two or more types of monomers.

In one aspect of the present invention, the aqueous resin constituting the aqueous resin emulsion (B) preferably has a chemical structure derived from a carboxylic acid ester polymer.

Here, a “chemical structure derived from a carboxylic acid ester polymer” means a chemical structure that includes a polymer of a carboxylic acid ester having an ethylenic double bond (whether a homopolymer or a copolymer) and any modification of such a polymer. A “carboxylic acid ester polymer” is obtained by polymerizing a polymerizable unsaturated monomer (b) containing a carboxylic acid ester (b1) having an ethylenic double bond.

In the present specification, the “carboxylic acid ester (b1) having an ethylenic double bond” (the “carboxylic acid ester (b1)” below) can be, for example, a (meth) acrylic acid ester such as methyl (meth)acrylate, ethyl (meth) acrylate, butyl (meth) acrylate, and 2-ethylhexyl (meth) acrylate; a vinyl carboxylate such as vinyl acetate, etc.; or an allyl carboxylate such as an allyl acetate. Note that in the present specification, a (meth) acrylic acid ester can be either an acrylic acid ester or a methacrylic acid ester.

In the present invention, the “carboxylic acid ester (b1) having an ethylenic double bond” is preferably methyl methacrylate, butyl acrylate, or vinyl acetate, and more preferably vinyl acetate. When the aqueous resin emulsion (B) contains a chemical structure derived from vinyl acetate, a coating agent for a paper base material in the present invention has an excellent balance of oil resistance, blocking resistance, surface coatability, and water resistance.

In the present embodiment, the carboxylic acid ester can be a copolymer of a carboxylic acid ester having an ethylenic double bond (b1) and a polymerizable unsaturated monomer (b2) other than a carboxylic acid ester having an ethylenic double bond (“the other monomer (b2)” below).

There are no particular restrictions on the other monomer (b2), which may be an olefin such as ethylene or propylene, styrene, or vinyl alcohol.

In the embodiment of the present invention, the aqueous resin emulsion (B) is preferably an emulsion containing a copolymer of ethylene and a carboxylic acid ester having an ethylenic double bond (“an ethylene/carboxylic acid ester copolymer emulsion having an ethylenic double bond” below), and more preferably one containing an ethylene/vinyl acetate copolymer emulsion.

When the aqueous resin emulsion (B) contains an ethylene/vinyl acetate copolymer emulsion, the paper base material coating agent of the present invention can maintain a high level of surface coatability.

There are no particular restrictions on the solid content concentration of the aqueous resin emulsion (B), but the solid content concentration is preferably from 5 to 70% by mass. Here, the solid content of the emulsion refers to the solid content obtained by drying the emulsion at 105° C. for three hours.

The aqueous resin emulsion (B) can be obtained, for example, by conducting emulsion polymerization on one or more types of polymerizable unsaturated monomer (b). Emulsion polymerization is a form of radical polymerization that uses water or an aqueous medium as the medium and an emulsifier. Any such method common in the art can be used.

The emulsifier is fixed to the surface of the polymer particles during or after polymerization in order to improve the dispersion stability of the particles. Examples of emulsifiers include anionic surfactants, nonionic surfactants, cationic surfactants, amphoteric surfactants, and polymeric surfactants. A “reactive surfactant” including a radically polymerizable double bond in the emulsifier molecule can also be used to improve water resistance, alkali resistance, and waterproof properties.

A commercially available aqueous resin emulsion (B) may be used. Examples of commercially available aqueous resin emulsions (B) that can be used in the present invention include Vinnapas EP707K (trade name) and Vinnapas EP705K (trade name) from Wacker Chemicals Korea, Inc.; ethylene-vinyl acetate copolymer emulsions such as Sumikaflex 408HQE (trade name) from Sumitomo Chemical; and vinyl acetate emulsions such as 225-1025 (trade name) from Henkel Japan Co., Ltd.

In the coating agent of the present invention, the added amount of component (A) is greater than 20 parts by mass and less than 50 parts by mass and preferably is 22 parts by mass or more and 48 parts by mass or less per 100 parts by mass of total amount of the solid content of component (A) and component (B).

The coating agent for a paper base material of the present invention has both oil resistance and blocking resistance when the mixing ratio of component (A) and component (B) is within the range mentioned above. When the amount of component (A) is too low, the blocking resistance of the coating agent declines, and if the amount of component (A) is too high, the oil resistance of the coating agent declines.

In the present embodiment, there are no particular restrictions on the total amount of component (A) and component (B) per 100 parts by mass of coating agent (excluding the solvent) in terms of solids, but the total amount is preferably 90 parts by mass or more and more preferably 95 parts by mass or more, and may even be 100 parts by mass.

In addition to components (A) and (B), the paper base material coating agent of the present invention may contain starch (C) (also referred to as “component (C)” below). The starch (C) increases the viscosity of the coating agent and improves the storage stability of a paper base material coating agent of the present invention.

There are no particular restrictions on the starch as long as the desired coating agent of the present invention can be obtained. A modified starch may be used. Examples of starches include natural starches such as corn starch, tapioca starch, potato starch, sweet potato starch, wheat starch, and rice starch; and modified starches obtained by modifying these natural starches, such as etherified starch, esterified starch, crosslinked starch, grafted starch, oxidized starch, acid decomposed starch, and dextrin.

The amount of component (C) may be 0 parts by mass per 100 parts by mass total of both component (A) and component (B) in terms of solid content, but is preferably 0.3 parts by mass or more and more preferably 0.5 parts by mass or more, and preferably 5 parts by mass or less and more preferably 4 parts by mass or less.

The paper base material coating agent in the embodiment of the present invention contains components (A) and (B), and optionally component (C). It may also contain additives, such as cross-linking agents, viscosity modifiers, plasticizers, antifoaming agents, preservatives, and colorants.

Examples of cross-linking agents include zinc acetate, zinc oxide, zirconium acetate, and ammonium zirconium carbonate. These cross-linking agents can be used alone or in combination.

Examples of viscosity modifiers include nitrogen-containing substances such as urea, urea compounds and dicyandiamide, calcium hydroxide, calcium oxide, sodium carbonate, trisodium phosphate, diammonium hydrogen phosphate, borax, sodium fluoride, water glass, and ammonia water.

Examples of plasticizers include glycerin; polyhydric alcohols such as ethylene glycol and propylene glycol; sugars such as sucrose and sorbitol; and organic solvents such as cellosolves.

Examples of antifoaming agents include silicone antifoaming agents such as dimethylpolysiloxane, polyoxyalkylene-modified silicone, organically modified polysiloxane, and fluorosilicone; oil-based antifoaming agents such as castor oil, sesame oil, linseed oil, and animal, and vegetable oils; fatty acid antifoaming agents such as stearic acid, oleic acid, and palmitic acid; fatty acid ester antifoaming agents such as isoamyl stearic acid, diglycol lauric acid, distearyl succinic acid, distearic acid, sorbitan monolaurate, glycerin fatty acid esters, polyoxyethylene sorbitan, butyl monolaurate stearate, sucrose fatty acid esters, and ethyl acetate alkyl esters of sulfonated ritinoleic acid; alcohol-based antifoaming agents such as polyoxyalkylene glycol and derivatives thereof, polyoxyalkylene alcohol hydrates, diamylphenoxyethanol, 3-heptanol, and 2-ethylhexanol; ether-based antifoaming agents such as 3-heptylcellosolve and nonylcellosolve-3-heptylcarbitol; phosphoric acid ester antifoaming agents such as tributyl phosphate, sodium octyl phosphate, and tris (butoxyethyl) phosphate; amine antifoaming agents such as diamylamine; amide antifoaming agents such as polyalkyleneamides, acylate polyamines, and dioctadecanoylpiperidine; metallic soap antifoaming agents such as aluminum stearate, calcium stearate, potassium oleate, and calcium salts of wool grease olein; and sulfonic acid ester antifoaming agents such as sodium lauryl sulfonate and sodium dodecyl sulfonate.

These additives may be added after the aqueous resin emulsion (B) has been synthesized, may be added together with the monomer raw materials of the aqueous emulsion resin (B), or may be added to the coating agent in emulsion form (a mixture of component (A) and component (B)). In the present specification, amounts included are in reference to the solid content of component (B) and do not include additives such as starch, antifoaming agents, and preservatives.

The coating agent of the present embodiment can be produced by mixing together component (A), component (B) and, if necessary, other components. These components may be heated during the mixing process. There are no particular restrictions on the order in which each component is added, the heating method used, and the stirring method used. Any method common in the art can be used.

The paper base material coating agent of the present invention can be applied, for example, to the surface of a paper base material used in food packaging. The coating agent in the embodiment of the present invention has excellent water resistance, oil resistance, surface coatability, and blocking resistance.

The paper base material coating agent of the present invention is directly applied to the surface of the paper base material, and can be applied as a single-component coating agent or as the undercoating (primer) of a two-component coating agent.

When a paper base material coating agent of the present invention is used as a primer, the overcoat (topcoat) is preferably an aqueous resin emulsion as well. The composition of the topcoat need not be limited to any particular composition as long as the object of the present invention can be achieved.

Any method common in the art can be used to apply a coating agent of the present invention to a paper base material. For example, a coating agent of the present invention can be applied to a paper base material using a conventional coating device such as a table coater, bar coater, two-roll size press coater, gate roll coater, blade metering coater, rod metering coater, blade coater, air knife coater, roll coater, brush coater, kiss coater, squeeze coater, curtain coater, die coater, gravure coater, or dip coater, and then dried.

There are no particular restrictions on the amount of coating agent applied to the paper base material, but the solid content (dry mass) can be, for example, from 5 to 100 g/m², preferably from 5 to 50 g/m², and more preferably from 10 to 20 g/m². Here, the solid content of a coating agent refers to the solid content after drying the coating agent at 105° C. for three hours.

One aspect of the present invention relates to a paper base material coated with a paper base material coating agent. A paper base material of the present invention is strongly resistant to water and oil. The coating film is not destroyed when the paper base material is folded, and deterioration in oil resistance is reduced. As a result, a paper base material of the present invention is suitable for use in a food packaging container.

One aspect of the present invention relates to a paper base material having a paper base material coating agent described above. There are no particular restrictions on the base material, which may be any known type of paper made from chemical pulp such as hardwood kraft pulp or softwood kraft pulp, mechanical pulp such as GP (ground wood pulp), RGP (refined ground pulp), or TMP (thermomechanical pulp), or may be any known synthetic paper. Other examples of paper base materials include high-quality paper, medium-quality paper, alkaline paper, glassine paper, semi-glassine paper, paperboard used in corrugated cardboard, building materials and chipboard, and white paperboard. The paper base material may contain organic and inorganic pigments, as well as papermaking aids such as paper strengthening agents, sizing agents, and yield improvers.

One aspect of the present invention relates to a paper product having a paper base material coated with a coating agent described above. Because paper products in embodiments of the present invention have excellent water resistance, they can be used not only in food packaging containers but also in paper straws, paper cups, and toilet paper. Because a paper product of the present invention includes a paper base material described above, the paper product of the present invention does not lose oil resistance or water resistance when folded, and can be used in a variety of applications, especially food packaging.

### EXAMPLES

The following is a detailed description of the present invention with reference to specific examples and comparative examples. However, these examples are only aspects of the present invention and the present invention is not limited in any way by these examples. In the examples and comparative examples, unless otherwise specified, all parts and percentages are mass based for components without consideration of the solvent.

The coating agents for paper base materials in Examples 1 to 15 and Comparative Examples 1 to 8 were produced using components (A) to (E) at the proportions shown in Tables 2 and 3. The numbers related to mixed amounts in Tables 2 and 3 represent the ratio in terms of solid content, and the units are parts by mass. The following are the specifics for components (A) to (E).

### (A) Celluloses

(A1) Cellulose fibers (average particle size: 10 μm (standard value: 6 to 12 μm), Arbocel UFC 100 (trade name) from Rettenmaier Japan Co., Ltd.)
(A2) Cellulose fibers (average fiber length (average particle size): 18 μm, average fiber diameter: 15 μm, Arbocel BE 600-10 (trade name) from Rettenmaier Japan Co., Ltd.)
(A3) Cellulose fibers (average fiber length (average particle size): 30 μm, average fiber diameter: 18 μm, Arbocel BE 600-30 (trade name) from Rettenmaier Japan Co., Ltd.)
(A′4) Cellulose fibers (average particle size: 50 μm, Vivapur101 (trade name) from Rettenmaier Japan Co., Ltd.)
(A′5) Cellulose fibers (average particle size: 3 nm, Rheocrysta I2SX (trade name) from Daiichi Kogyo Seiyaku Co., Ltd.)

### (B) Aqueous Resin Emulsions

(B1) Ethylene/vinyl acetate (EVA) copolymer emulsion (Vinnapas EP707K (trade name) from Wacker Chemicals Korea Inc.)
(B2) Ethylene/vinyl acetate (EVA) copolymer emulsion (Vinnapas EP705K (trade name) from Wacker Chemicals Korea Inc.)
(B3) Ethylene/vinyl acetate (EVA) copolymer emulsion (Sumikaflex 408HQE (trade name) from Sumitomo Chemical Co., Ltd.)
(B4) Vinyl acetate emulsion (225-1025 (trade name) from Henkel Japan Ltd.)
(B′5) Acrylic acid resin (Solurly 840 (trade name) from Hanwha Q Cells Japan Co., Ltd.)

### (C) Starches

(C1) Modified starch (SDRN2 (trade name) from Nichiden Kagaku Co., Ltd.)
(C2) Modified starch (Piostarch (trade name) from Nippon Starch Chemical Co., Ltd.)

### (D) Antifoaming Agent

(D1) Silicone antifoaming agent (KM72GS (trade name) from Shin-Etsu Chemical Co., Ltd.)

### (E) Preservative

(E1) Acticide MB (Thor Japan Co., Ltd.)

### Production of Coating Agent in Example 1

First, 60 parts by mass of distilled water was added to a three-necked flask equipped with a stirrer, thermometer and reflux condenser, and then 75 parts by mass of component (B1) and 1 part by mass of component (C1) were added as shown in Table 2. The liquid temperature was kept at 80° C. while stirring the contents of the three-necked flask. Next, 25 parts by mass of component (A1) was slowly added, and the liquid temperature was kept at 80° C. while stirring the contents for two hours until homogeneous.

After confirming that components (A1), (B1) and (C1) were dispersed uniformly in the water inside the three-necked flask, the aqueous resin dispersion (aqueous resin emulsion) was cooled. Then, components (D1) and (E1) were added dropwise to complete the coating agent.

### Production of Coating Agent in Examples 2 to 15 and Comparative Examples 1 to 7

The coating agents in Examples 2 to 15 and Comparative Examples 1 to 7 were produced in the same manner as Example 1, except that each component was changed as shown in Tables 2 and 3. Tables 2 and 3 show the test results for the resulting coating agents.

### Production of Coating Agent in Comparative Example 8

First, 180 parts by mass of distilled water, 20 parts by mass of 25% aqueous ammonia, 60 parts by mass of component (B′5), and 1 part by mass of component (C1) were added to a three-necked flask equipped with a stirrer, thermometer and reflux condenser. The liquid temperature was kept at 80° C. while stirring the contents of the three-necked flask. After confirming that component (B′5) had completely dissolved in the aqueous medium, 40 parts by mass of component (A1) was slowly added, and the liquid temperature was raised to 80° C. while stirring for two hours so that each component was mixed uniformly.

Components (A1) and (C1) were uniformly dispersed in the aqueous medium inside the three-necked flask, and after confirming that component (B′5) had dissolved, the aqueous resin dispersion (aqueous emulsion) was cooled. Then, components (D1) and (E1) were added dropwise to complete the coating agent.

The coating agents in Examples 1 to 15 and Comparative Examples 1 to 8 were applied to a paper base material to evaluate the coating agents for oil resistance, blocking resistance, surface coatability, water resistance, and folded paper base material oil resistance. The evaluation tests will now be described in detail.

### <Oil Resistance Test>

A kit test was performed according to the Tappi T559 cm-12 method as described below.

Test paper was prepared by coating high-quality paper with each coating agent using a table coater. In this test, the test solutions were mixtures of castor oil, toluene, and n-heptane prepared at the ratios shown in Table 1. The test results are shown by kit number, and a larger number indicates better oil resistance.

The oil resistance of the test paper can be determined in a short period of time (about 20 seconds) using a kit test, and kit tests are widely used to evaluate the oil resistance of paper. The evaluation results have significance as an indicator of the surface tension on the paper surface.

The test paper was placed on a clean, flat, black surface and a drop of test solution from Kit No. 12 was dropped on the test paper from a height of 13 mm. Fifteen seconds after the drop fell (contact time: 15 seconds), the test solution was removed with clean blotting paper, and the surface of the test paper was visually inspected where it made contact with the test solution. When the color of the surface became darker, the same operation was performed using the test solution in Kit No. 11. The same operation was repeated while incrementally decreasing the kit number until a kit number did not darken the color of the surface. The first (highest) kit number that did not darken the surface indicates the oil resistance of the coating agent. For example, an oil resistance evaluation of Kit No. 11 indicates that Kit No. 12 darkened the color of the surface (permeated the surface), but Kit No. 11 did not darken the color of the surface (did not permeate the surface).

TABLE 1

| Kit | Castor Oil | Toluene | Heptane |
|---|---|---|---|
| No. | Mass (g) | Volume (ml) | Volume (ml) |
| 1 | 969 | 0 | 0 |
| 2 | 872.1 | 50 | 50 |
| 3 | 775.2 | 100 | 100 |
| 4 | 678.3 | 150 | 150 |
| 5 | 581.4 | 200 | 200 |
| 6 | 484.5 | 250 | 250 |
| 7 | 387.6 | 300 | 300 |
| 8 | 290.7 | 350 | 350 |
| 9 | 193.8 | 400 | 400 |
| 10 | 96.9 | 450 | 450 |
| 11 | 0 | 500 | 500 |
| 12 | 0 | 450 | 550 |

The following were the evaluation criteria.
⊙ . . . Kit Nos. 12 to 7
◯ . . . Kit Nos. 6 to 3
Δ . . . Kit No. 2
x . . . Kit Nos. 1 to 0

### <Blocking Resistance Test>

A sample was prepared by applying a coating agent on high-quality paper to a coating amount of 15 g/m² (dry weight) using a bar coater, and drying the coating agent at 130° C. for three minutes. The coated surface of the sample was overlaid with a non-coated surface (back side) of paper and 200 N of pressure was applied at a temperature of 40° C. for two hours before removing the sample. The sample was allowed to stand at room temperature for two or more hours before observing the 180° peel strength and release state of the pressure-applied surface. The following were the evaluation criteria.
⊙ . . . The release surface had interfacial peeling (peeling at the interface between the high-quality paper and the coating), and the peel strength was 1.0 N/25 mm or less.
◯ . . . The release surface had interfacial peeling, and the peel strength was higher than 1.0 N/25 mm and 1.5 N/25 mm or less.
Δ . . . The release surface had interfacial peeling, and the peel strength was higher than 1.5 N/25 mm.
x . . . There was material failure on the release surface (the high-quality paper was damaged).

### <Surface Coatability Test>

A sample was prepared by applying a coating agent on high-quality paper to a coating amount of 15 g/m² (dry weight) using a bar coater, and drying the coating agent at 130° C. for three minutes. The coated surface of the sample was observed, and the surface properties were evaluated by touch. The following were the evaluation criteria.

⊙ . . . Unevenness was imperceptible to the touch

◯ . . . Slight unevenness was perceptible to the touch
Δ . . . Some unevenness was perceptible to the touch
x . . . Unevenness was clearly perceptible to the touch

### <Water Resistance Test>

A sample was prepared by applying a coating agent on high-quality paper to a coating amount of 15 g/m² (dry weight) using a bar coater, and drying the coating agent at 130° C. for three minutes. After the coating agent had dried, the high-quality paper was cut into a circle with a diameter of 10 cm, and the mass was measured. The piece of high-quality paper was placed securely inside a round cylindrical flask with an inner diameter of 7 cm and an open top, 50 ml of distilled water was dropped from above, and paper allowed to stand for 30 minutes.

Afterward, the distilled water was removed, the sample was taken out of the round cylinder, and the mass of the paper was measured after the water droplets on the surface of the sample had been removed. The change in mass of the sample before and after the test was calculated, and the increased mass was considered to be the amount of water absorption. The amount of water absorption per unit area was then calculated. The following were the evaluation criteria.
⊙ . . . The amount of water absorption was less than 50 g/m².
◯ . . . The amount of water absorption was from 50 to 100 g/m².
Δ . . . The amount of water absorption was greater than 100 g/m² and less than 140 g/m².
x . . . The amount of water absorption was greater than 140 g/m².
   <Oil Resistance Test with Folded Paper Base Material>

A sample was prepared by applying a coating agent on high-quality paper to a coating amount of 15 g/m² (dry weight) using a bar coater, and drying the coating agent at 130° C. for three minutes. Folds were made in the same direction and perpendicular to the coating direction, and a load of 2 kg was applied in the coating direction using a roller. The roller was applied only once. Drops of castor oil were dropped on the folded surface of the paper base material, and the sample was allowed to stand at room temperature for 10 minutes and at 60° C. for 30 minutes. The following were the evaluation criteria.
⊙ . . . No penetration
◯ . . . 1 to 3 pinholes occurred
Δ . . . 4 to 5 pinholes occurred
x . . . 6 or more pinholes occurred or penetration occurred over the entire surface

Tables 2 and 3 show the composition of and test results for each coating agent.

TABLE 2

| | | Ex. | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 |
| A1 | | 25 | 30 | 35 | 40 | 45 | | | 35 | 35 | 35 | 32 | 32 | 25 | 35 | 45 |
| A2 | | | | | | | 35 | | | | | | | | | |
| A3 | | | | | | | | 35 | | | | | | | | |
| A′4 | | | | | | | | | | | | | | | | |
| A′5 | | | | | | | | | | | | | | | | |
| B1 | | 75 | 70 | 65 | 60 | 55 | 65 | 65 | | | | | | 75 | 65 | 55 |
| B2 | | | | | | | | | 65 | | | 68 | 68 | | | |
| B3 | | | | | | | | | | 65 | | | | | | |
| B4 | | | | | | | | | | | 65 | | | | | |
| B′5 | | | | | | | | | | | | | | | | |
| C1 | | 1 | 1 | 1 | 1 | 1 | 1 | 1 | 1 | 1 | 1 | 3 | | | | |
| C2 | | | | | | | | | | | | | 3 | | | |
| D1 | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| E1 | | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| Oil | Evaluation | ⊙ | ⊙ | ⊙ | ⊙ | ◯ | ◯ | ◯ | ⊙ | ⊙ | ⊙ | ◯ | ◯ | ⊙ | ⊙ | ◯ |
| Resistance | Kit No. | 11 | 10 | 7 | 7 | 3 | 3 | 3 | 10 | 10 | 10 | 3 | 3 | 10 | 7 | 3 |
| Test | | | | | | | | | | | | | | | | |
| Blocking | Evaluation | ◯ | ◯ | ◯ | ◯ | ⊙ | ⊙ | ⊙ | ◯ | ◯ | ◯ | ◯ | ◯ | ◯ | ◯ | ⊙ |
| Resistance | Peel | 1.4 | 1.2 | 1.2 | 1.1 | 1.0 | 1.0 | 0.8 | 1.1 | 1.2 | 1.2 | 1.1 | 1.1 | 1.4 | 1.2 | 1.0 |
| Test | Strength | | | | | | | | | | | | | | | |
| | (N/25 mm) | | | | | | | | | | | | | | | |
| Surface | Evaluation | ◯ | ⊙ | ⊙ | ⊙ | ⊙ | ◯ | ◯ | ◯ | ◯ | ◯ | ⊙ | ⊙ | ◯ | ⊙ | ⊙ |
| Coating | | | | | | | | | | | | | | | | |
| (Touch) Test | | | | | | | | | | | | | | | | |
| Water | Evaluation | ⊙ | ⊙ | ◯ | ◯ | ◯ | ◯ | ◯ | ◯ | ◯ | ◯ | ◯ | ◯ | ⊙ | ◯ | ◯ |
| Resistance | Absorbency | 10 | 25 | 80 | 80 | 85 | 90 | 90 | 80 | 70 | 65 | 80 | 85 | 45 | 80 | 85 |
| Test | (g/m²) | | | | | | | | | | | | | | | |
| Oil | Evaluation | ⊙ | ⊙ | ⊙ | ◯ | ◯ | ◯ | ◯ | ⊙ | ⊙ | ⊙ | ⊙ | ⊙ | ⊙ | ⊙ | ◯ |
| Resistance | No. of Pin | 0 | 0 | 0 | 1 | 2 | 2 | 3 | 0 | 0 | 0 | 0 | 0 | 0 | 0 | 3 |
| Test | Holes | | | | | | | | | | | | | | | |
| w/Folded | | | | | | | | | | | | | | | | |
| Paper Base | | | | | | | | | | | | | | | | |
| Material | | | | | | | | | | | | | | | | |

TABLE 3

| | | C. | C. | C. | C. | C. | C. | C. | C. |
|---|---|---|---|---|---|---|---|---|---|
| | | Ex. | Ex. | Ex. | Ex. | Ex. | Ex. | Ex. | Ex. |
| | | 1 | 2 | 3 | 4 | 5 | 6 | 7 | 8 |
| A1 | | 0 | 5 | 10 | 20 | 50 | | | 40 |
| A2 | | | | | | | | | |
| A3 | | | | | | | | | |
| A′4 | | | | | | | 35 | | |
| A′5 | | | | | | | | 1 | |
| B1 | | 100 | 95 | 90 | 80 | 50 | 65 | 99 | |
| B2 | | | | | | | | | |
| B3 | | | | | | | | | |
| B4 | | | | | | | | | |
| B′5 | | | | | | | | | 60 |
| C1 | | 1 | 1 | 1 | 1 | 1 | 1 | 1 | 1 |
| C2 | | | | | | | | | |
| D1 | | 0.1 | 0.1 | 0.1 | 0.1 | 0.1 | 0.1 | 0.1 | 0.1 |
| E1 | | 0.2 | 0.2 | 0.2 | 0.2 | 0.2 | 0.2 | 0.2 | 0.2 |
| Oil | Evaluation | ⊙ | ⊙ | ⊙ | ⊙ | X | X | ⊙ | X |
| Resistance | Kit No. | 12 | 11 | 11 | 11 | 1 | 0 | 11 | 0 |
| Test | | | | | | | | | |
| Blocking | Evaluation | X | X | X | X | ⊙ | ⊙ | X | ⊙ |
| Resistance | Peel | Paper | Paper | Paper | Paper | 1.0 | 0.7 | Paper | 1.0 |
| Test | Strength | Dam- | Dam- | Dam- | Dam- | | | Dam- | |
| | (N/25 mm) | aged | aged | aged | aged | | | aged | |
| Surface | Evaluation | ◯ | ◯ | ◯ | ◯ | ⊙ | X | X | Δ |
| Coating | | | | | | | | | |
| (Touch) | | | | | | | | | |
| Test | | | | | | | | | |
| Water | Evaluation | ⊙ | ⊙ | ⊙ | ⊙ | Δ | X | Δ | X |
| Resistance | Absorbency | 5 | 7 | 7 | 10 | 110 | 140 | 105 | 150 |
| Test | (g/m²) | | | | | | | | |
| Oil | Evaluation | ⊙ | ⊙ | ⊙ | ◯ | Δ | X | ⊙ | X |
| Resistance | No. of | 0 | 0 | 0 | 1 | 5 | 10 | 0 | 10 |
| Test | Pin | | | | | | | | |
| w/Folded | Holes | | | | | | | | |
| Paper | | | | | | | | | |
| Base | | | | | | | | | |
| Material | | | | | | | | | |

As shown in Table 2, the coating agents in the examples received either ⊙ or ◯ in the evaluation tests, indicating an excellent balance of performance characteristics.

As shown in Table 3, the coating agents in the comparative examples received x in at least one of the evaluation tests. The coating agents in Comparative Examples 1 to 4 had poor blocking resistance because the amount of cellulose (A) added was too low. The coating agent in Comparative Example 5 had low oil resistance because the amount of cellulose (A) added was too high.

The coating agent in Comparative Example 6 had low oil resistance because the average particle size of cellulose (A′4) was too high. The coating agent in Comparative Example 7 had low oil resistance because the average particle size of cellulose (A′5) was too low.

The coating agent in Comparative Example 8 had both low oil resistance and water resistance because it did not contain an aqueous resin emulsion (B) but contained a water-soluble resin (B′5).

### INDUSTRIAL APPLICABILITY

The present invention can provide a coating agent that is applied to the surface of paper. In one aspect of the present invention, a paper product is produced by applying the coating agent to the paper surface. This paper product can be a food packaging container, paper cup, or paper straw.

1. A coating agent for a paper base material comprising:
(A) cellulose with an average particle size of 1 μm to 40 μm;
(B) a vinyl acetate emulsion or an ethylene/vinyl acetate copolymer emulsion;
(C) a modified starch; and
(D) an antifoaming agent;
wherein the amount of component (A) per 100 parts by mass of the total amount of component (A) and component (B) in terms of solid content is more than 20 parts by mass and less than 50 parts by mass.

2. (canceled)

3. (canceled)

4. A paper base material comprising the coating agent according to claim 1.

5. A paper product having a paper base material according to claim 4.

6. The paper product according to claim 5, wherein the peel strength of the interfacial peeling is 1.0N/25 mm or less;
wherein the peel strength is measure by (1) applying the coating agent on a paper base material with a coating amount of 15 g/m² (dry weight), (2) drying the coating agent at 130° C. for three minutes, (3) overlaying a non-coated surface of paper base material with 200 N of pressure and 40° C. for two hours, (4) allowing to equilibrate at room temperature for at least two hours, and (5) testing for 180° peel strength.

7. The paper product according to claim 5, wherein the water absorption is less than 50 g/m²,
wherein the absorption is measured by (1) applying 15 g/m² (dry weight) of the coating agent onto a paper base material, (2) drying the coating agent at 130° C. for three minutes, (3) cutting the paper base material with the dried coating into a 10 cm diameter circle, (4) measure the mass of the circle, (5) testing the circle in a round cylindrical flask with an inner diameter of 7 cm and an open top, dropping 50 ml of distilled water from above, and allowing the circle to stand for 30 minutes, and (6) measuring the mass and calculating the amount of water absorption per unit area.
